(19) United States
(12) Patent Application Publication
(10) Pub. No.: US 2025/0135323 A1
(43) Pub. Date: May 1, 2025

(54) EVENT MANAGEMENT APPARATUS, COMPUTER PROGRAM AND SYSTEM

(71) Applicant: BANDAI CO., LTD., Tokyo (JP)

(72) Inventors: Yushiro UEHARA, Tokyo (JP); Yusaku KUBOTA, Tokyo (JP)

(21) Appl. No.: 18/927,988

(22) Filed: Oct. 26, 2024

(30) Foreign Application Priority Data
Oct. 31, 2023 (JP) 2023-186568

(51) Int. Cl. A63F 1/18; A63F 11/00

(52) U.S. Cl. CPC A63F 1/18; A63F 11/0051; A63F 11/0074; A63F 2011/0058; A63F 2011/0072

(57) ABSTRACT

An event management apparatus which can communicate with a user terminal comprises a presentation control unit configured to present multiple first game media and multiple events using second game media corresponding to the first game media, to the user terminal, a deck creation control unit configured to create a deck based on a first game medium selected from the presented multiple first game media, and a registration control unit configured to register the created deck, two or more events including a first event and a second event, which are selected from the multiple events, wherein the registration control unit perform control so that the second game media can be registered according to relationship between the first event and the second event.

### CROSS-REFERENCE TO RELATED APPLICATIONS

The disclosure of Japanese Patent Application No. 2023-186568 filed on Oct. 31, 2023 including specification, drawings and claims is incorporated herein by reference in its entirety.

### TECHNICAL FIELD

The present invention relates to an apparatus, computer program, and system for managing events.

### BACKGROUND

Conventionally, systems that improve the convenience for users participating in an event have been known. For example, Japanese Patent Application Publication No. 2014-171859 discloses a game system designed to enhance the convenience of users participating in a game.

### SUMMARY

### Technical Problem

In such a situation, there is a demand for technology for providing an event in which the convenience of users is improved. The present invention is made to solve such a problem, and it is an object of the present invention to provide an apparatus, a computer program, and an event management system for improving the convenience of users who participate in the event.

### Solution to Problem

[1] One of the aspects of the present invention is an event management apparatus, which is communicably connected to a user terminal. The event management apparatus comprises a presentation control unit which allows presentation of a plurality of first game media and a plurality of events using second game media, which correspond to the first game media to the user terminal, a deck creation control unit which allows creation of a deck made up of or including first game media (medium) selected from the presented first game media, a registration control unit which allows registration of the created deck, and two or more events including first and second events selected from among multiple events, wherein the registration control unit performs control so that the second event can be registered based on the relationship between the first event and the second event.
[2] Another aspect of the present invention is an event management computer program. The event management computer program causes one or more computers to function as a presentation control unit which allows presentation of a plurality of first game media and a plurality of events using second game media, which correspond to the first game media to the user terminal, a deck creation control unit which allows creation of a deck made up of or including first game media (medium) selected from the presented first game media, a registration control unit which allows registration of the created deck, and two or more events including first and second events selected from among multiple events, wherein the registration control unit performs control so that the second event can be registered based on the relationship between the first event and the second event.
[3] Still another aspect of the present invention relates to an event management system comprises a user terminal and an event management apparatus communicably connected to the user terminal. The system includes a presentation control unit which allows presentation of a plurality of first game media and a plurality of events using second game media, which correspond to the first game media, to the user terminal, a deck creation control unit which allows creation of a deck made up of or including first game media (medium) selected from the presented plurality of first game media, a registration control unit which allows registration of the created deck, and two or more events including a first event and a second event selected from among multiple events, wherein the registration control unit performs control so that the second event can be registered based on the relationship between the first event and the second event.

### Advantageous Effect of Invention

According to the present invention, it is possible to provide an event with greater convenience for users who participate therein.

### BRIEF DESCRIPTION OF DRAWINGS

FIG. 1 is a diagram showing an overall configuration of a system according to an embodiment of the present invention;

FIG. 2 illustrates a hardware configuration of the system according to an embodiment of the present invention;

FIG. 3 is a functional block diagram of the system according to an embodiment of the present invention;

FIG. 4A shows an example of data table A which is stored in a memory unit according to an embodiment of the present invention;

FIG. 4B shows an example of data table B which is stored in a memory unit according to an embodiment of the present invention;

FIG. 4C shows an example of data table C which is stored in a memory unit according to an embodiment of the present invention;

FIG. 5 shows a flowchart showing a process according to an embodiment of the present invention;

FIG. 6 shows a flowchart showing a process according to another embodiment of the present invention;

FIG. 7 shows an example of a screen of an application according to an embodiment of the present invention;

FIG. 8 shows an example of a screen of the application according to an embodiment of the present invention;

FIG. 9 shows an example of a screen of the application according to an embodiment of the present invention; and

FIG. 10 is a flowchart showing a process according to an embodiment of the present invention.

### DETAILED DESCRIPTION

An event management system 1 according to the embodiment of the present invention, which is a system for managing events, and an event management apparatus according thereto, which is an apparatus for managing events, will be described, referring to the drawings. In this specification, for convenience of explanation, excessively detailed explanations may be omitted. For example, detailed explanations of well-known matters or repetitive explanations of substantially the same configuration may be omitted.

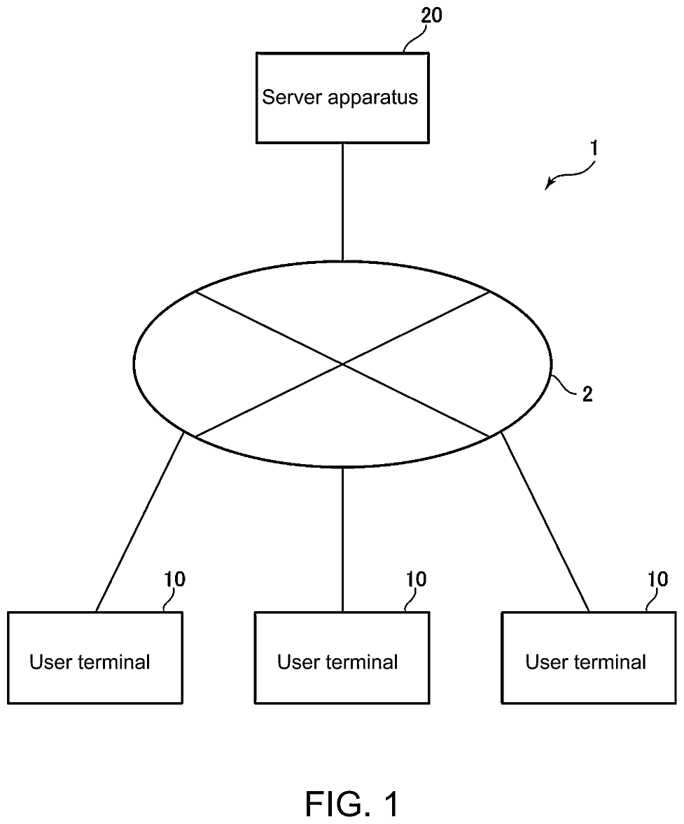

FIG. 1 shows an example of the overall configuration of the event management system 1 according to an embodiment of the present invention. As shown in FIG. 1, the event management system 1 includes multiple user terminals 10 and a server apparatus 20. The server apparatus 20 is an example of an event management apparatus. The user terminals 10 and the server apparatus 20 are connected to a network 2 such as the Internet and can communicate with each other. By using this system, it is possible to provide event management services to users operating the user terminals 10.

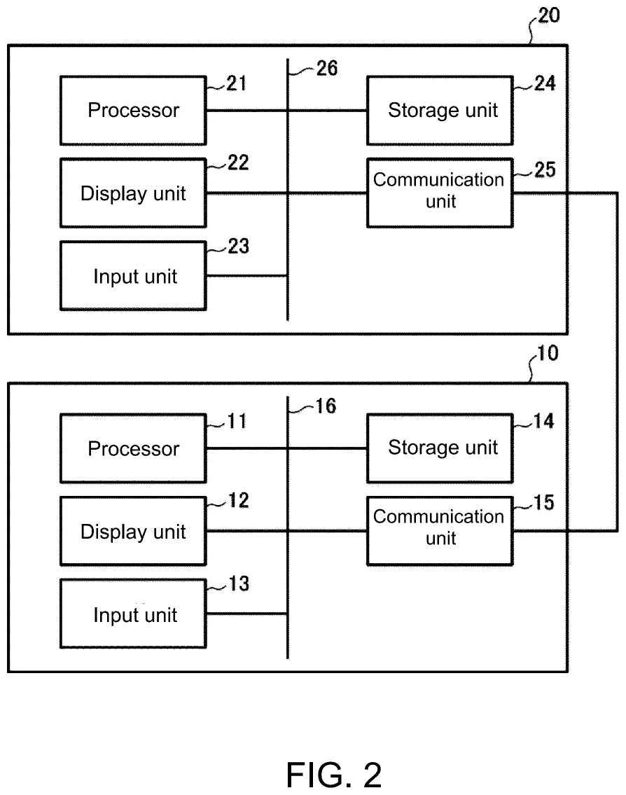

FIG. 2 is a block diagram showing the hardware configuration of one of the user terminals 10 and the server apparatus 20 according to one embodiment of the present invention. The user terminal 10 includes a processor 11, a display unit 12, an input unit 13, a storage unit 14, and a communication unit 15. These constituent devices are connected one another by a bus 16. An interface may be interposed between the bus 16 and each constituent device as necessary. In this embodiment, the user terminal 10 is a smartphone. However, as long as the user terminal 10 includes the above configuration, it may be a tablet computer, a computer with a touchpad, a notebook computer, or a desktop computer which has a tangible input unit.

Similarly, the server apparatus 20 includes a processor 21, a display unit 22, an input unit 23, a storage unit 24, and a communication unit 25. These constituent devices are respectively connected to one another by a bus 26. An interface may be interposed between the bus 26 and each constituent device as necessary. In this embodiment, the server apparatus 20 is realized by a computer.

The processors 11 and 21 control the respective overall operations of the user terminals 10 and the server apparatus 20, and are, for example, CPUs. Note that MPUs or other electronic circuits may be used as the processors 11 and 21. The processors 11 and 21 perform various processes by reading and executing programs and data stored in the respective storage units 14 and 24.

The display units (display) 12 and 22 respectively display application screens and the like, to the users of the user terminals 10 and the server apparatus 20 under the control of the processors 11 and 21. Preferably, the display units are liquid crystal displays respectively, but they may also be displays using organic EL, plasma displays, or the like.

The input units 13 and 23 are user interfaces that accept an input from users to the user terminals 10 and the server apparatus 20, respectively, and they may be for example, touch panels, touch pads, keyboards, or mice, respectively. In this embodiment, since the user terminal 10 is a smartphone, the user terminal 10 includes a touch panel as the input unit 13, which also functions as the display unit 12, wherein the display unit 12 and the input unit 13 have an integrated structure. The display unit 12 and the input unit 13 may be separate from each other and located in different places. Since the server apparatus 20 is a computer, it includes a keyboard and a mouse as input units, and a liquid crystal display as the display unit.

Each of the storage units 14 and 24 includes a main memory, a buffer memory, and a storage, and they are storage units or magnetic storage units found in general smartphones and computers, such as RAM, which is a volatile memory, and eMMC, UFS, SSD, which is a non-volatile memory. Each of the storage units 14 and 24 may also include an external memory. For example, the storage unit 14 stores applications therefor, and the storage unit 24 stores server applications therefor. The applications include programs for executing the applications and various data to be referred to when the programs are executed.

The communication units 15 and 25 can respectively transmit and receive data to and from other devices via the network 2 (omitted in FIG. 2). For example, the communication units 15 and 25 respectively perform wireless communication such as mobile communication or wireless LAN to connect to the network 2. The user terminal 10 communicates with the server apparatus 20 via the network by using the communication unit 15. Also, the communication units 15 and 25 may respectively perform wired communication using Ethernet (Registered Trademark) cables, etc.

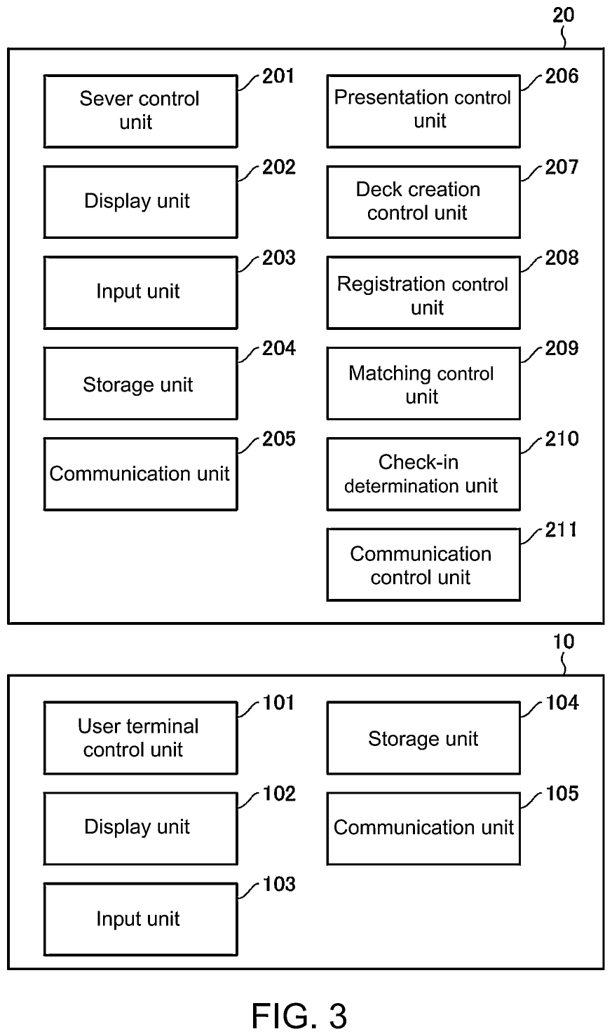

FIG. 3 shows an example of the functional block diagram of the user terminal 10 and the server apparatus 20 according to an embodiment of the present invention. The user terminal 10 includes a user terminal control unit 101, a display unit 102, an input unit 103, a storage unit 104, and a communication unit 105. The server apparatus 20 includes a server control unit 201, a display unit 202, an input unit 203, a storage unit 204, a communication unit 205, a presentation control unit 206, a deck creation control unit 207, a registration control unit 208, a matching control unit 209, a check-in determination unit 210 and a notification control unit 211. In this embodiment, these functions are realized by executing the program by at least one of the processors 11 and 21. For example, the programs to be executed are stored in the storage units 14 and 24. Thus, since various functions are realized by reading programs, part or all the parts of one part (function) may be included in the other part. These functions may also be realized by configuring electronic circuits or other hardware to achieve part or all of the functions.

The user terminal control unit 101 of the user terminal 10 performs control and processing for executing the functions of the application according to this embodiment. The application may be a dedicated application prepared to realize this embodiment, or it may be an application used for other purposes such as a general-purpose browser. The display unit 102 displays an application screen for controlling the functions of the application and displays the application screen(s) corresponding to the functions of the application and user operations. When the application is a browser, the screen is a browser screen.

The input unit 103 accepts an input from the user of the user terminal 10. In this embodiment, a touch panel including both the display unit 102 and the input unit 103 is used, and the input unit is realized by a touch detection function. The storage unit 104 stores information necessary for the information processing executed by the control unit 101 of the user terminal, and for example, it stores data of virtual game media (first game media) and the like, received from the server apparatus 20. In this embodiment, the virtual game media is electronic data that includes information about the actual game media (second game media) which are cards used in a card game. The actual game medium corresponding to one virtual game medium is associated with a character which is the same as that associated with that virtual game medium. The communication unit 105 can communicate with the communication unit 205 of the server apparatus 20 via the network 2.

The server control unit 201 of the server apparatus 20 performs processing that should be executed in the server apparatus 20 for the application executed on the user terminal 10. The display unit 202 displays a management screen for a server administrator on the display unit 22 as necessary. The input unit 203 accepts a user input from a user such as the server administrator of the server apparatus 20. The communication unit 205 can communicate with the communication unit 105 of the user terminal 10 via the network 2. For example, the server control unit 201 receives a user ID and password etc. from the user terminal 10, authenticates the user, and communicates with the authenticated user terminal 10, allowing the user of the user terminal 10 to use the services provided by the server apparatus 20 as the user of the authenticated user ID.

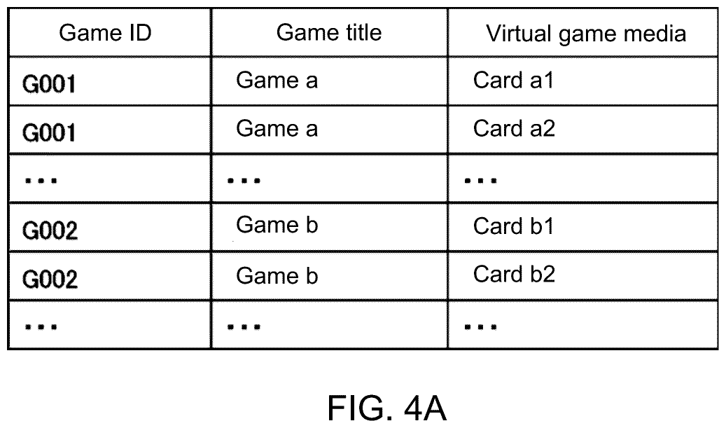

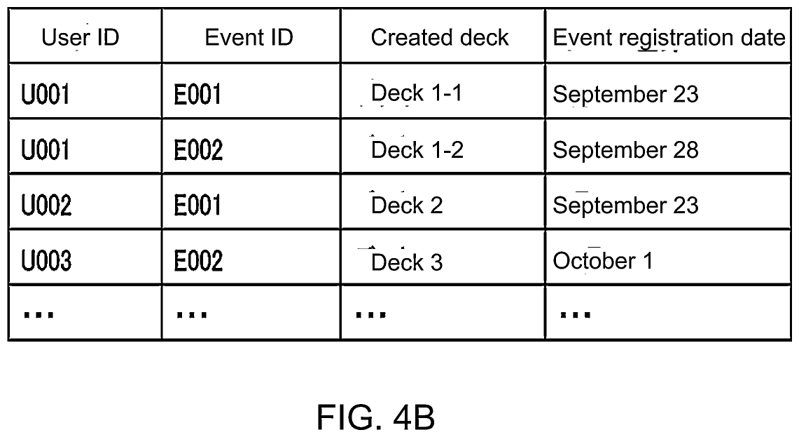

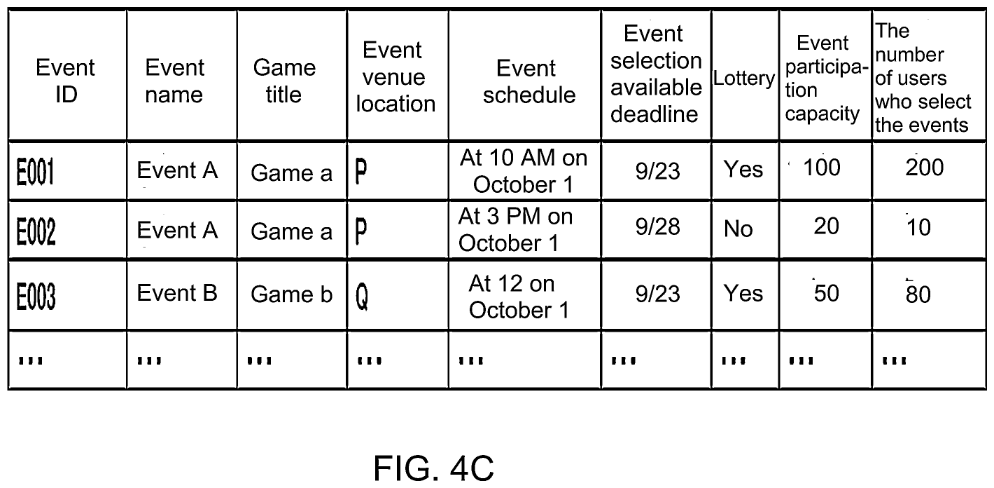

The storage unit 204 associates game titles with game identifiers (IDs) respectively and stores them. Additionally, the storage unit 204 associates virtual game media with game IDs and store them. The game ID is an example of game identification information that can identify a game. In this embodiment, a game title indicates a type of battle card game using cards which are actual game media. In this embodiment, in the storage unit 204, as shown in a table A in FIG. 4A, game titles are respectively associated with game IDs and stored, and each of multiple virtual game media is associated with a game ID. FIG. 4A shows an example of the table A. In the table A shown in FIG. 4A, for example, a game ID G001 is associated with a game title which is Game a, a game ID G002 is associated with a game title which is Game b, the game ID G001 is associated with virtual game media which are Cards a1, a2 . . . , and the game ID G002 is associated with virtual game media, Cards b1, b2, . . . .

The storage unit 204 stores information such as user data of users registered as users of the event management service, event data of events selected by users from multiple events, and deck creation data of decks created by users and so on. In the present embodiment, event identifiers (IDs) are associated with user identifiers (IDs) and stored in the storage unit 204. Additionally, the created deck data and event registration dates are associated with the user IDs and the event IDs and are stored in the storage unit 204. The user ID is an example of user identification information that can identify a user. The event ID is an example of event identification information that can identify an event. FIG. 4B is a diagram showing an example of a table B. In the table B shown in FIG. 4B, for example, a created deck, Deck 1-1 and an event registration date, September 23, are stored in association with a user ID, U001 and an event ID, E001, and a created deck, Deck 1-2 and an event registration date, September 28 are stored in association with the user, ID U001 and an event, ID E002.

The storage unit 204 stores event names, game titles, event venue locations, event schedule (event date), event selection available deadline, information as to whether or not there is a lottery, the event participation capacity, and the current number of users who select the event, with event IDs. FIG. 4C shows an example of a table C. In the table C shown in FIG. 4C, for example, an event name which is Event A, a game title which is Game a, an event venue location P, event schedule which is 10:00 on October 1, an event selection available deadline which is September 23, information as to the existence of a lottery, an event participation capacity which is 100 users, and a current user selection count which is 200, an event ID, which is E001 are stored so as to be associated with an event ID E0001. Multiple event IDs may be associated with the same event name. For example, in the table C shown in FIG. 4C, the event IDs E001 and E002 are associated with the same event name which is Event A. Here, Event A with different time slots on the same day is associated with different event IDs. P represents location information indicating the event venue location, which may be address information such as XX City, XX Prefecture, or latitude and longitude information.

The user ID is an example of user identification information that can identify a user and can be used to identify a user. The user is a user of the event management service provided by this system. The user information can be associated with the user ID. The user information may include the user's name, phone number, email address, address, the game titles selected by the user, and the language of the selected game title(s).

The created deck data is data of a deck, which is made up of virtual game media which the user select from multiple virtual game media displayed on the display unit 102 of the user terminal 10. Multiple decks may be created.

The event ID is an example of event identification information that can identify an event and can be used to identify an event. As shown in a table C of FIG. 4C, the event ID can be associated with event-related information, such as the event name, game title, event venue location, event schedule (event date), event selection available deadline, information as to whether or not there is a lottery, event participation capacity, and the current number of users who select the event. The event-related information may be information entered by the event organizer using the event management service provided by this system. In the present embodiment, the event is a competitive or match game event using real game media such as cards of a card game. To participate in the event, the user may be required to win a lottery. The number of users who can participate in the event may be set to a fixed number as the event's participation capacity. It may be configured so that in case where the number of users wishing to participate therein exceeds the event's participation capacity, a lottery may be associated with the event ID, and only those who win the lottery may participate.

The presentation control unit 206 presents multiple virtual game media and multiple events to the user via the display unit 102 of the user terminal 10. In the present embodiment, the multiple virtual game media are electronic data corresponding to multiple real game media of the card game. The presentation control unit 206 may present multiple virtual game media associated with the game titles selected by the user, which are included in the user data.

The presentation control unit 206 presents user's opponent information, which indicates information about the user's opponent in the event, to the user via the display unit 102 of the user terminal 10. In the present embodiment, the opponent information includes the opponent's user name, the deck registered by the opponent user, and the table number where the competitive game is played. The presentation of the opponent information may be conditional on the user's check-in at the event venue.

The deck creation control unit 207 creates a deck based on the virtual game media selected by the user from among the multiple virtual game media presented on the user terminal 10. Each virtual game medium can be associated with a corresponding character. The same character can be associated with multiple virtual game media. That is, one character can be associated with one virtual game medium and also with another virtual game medium. The deck creation control unit 207 may create a deck based on multiple virtual game media associated with the same character. Additionally, the deck creation control unit 207 may also create a deck based on two or more of the same one virtual game media.

The registration control unit 208 associates and registers the information stored by the aforementioned storage unit 204.

The registration control unit 208 may allow the user to select an event and register the event ID even after the event selection available deadline associated with the event, provided the number of users selecting the event is less than the event's participation capacity. For instance, in the table C shown in FIG. 4C, an event with the event ID which is Event E002 has an event selection available deadline which is September 28, and after the deadline, that is, on September 29 or later, the event would normally not be selectable. However, since the participation limit for the event is 20 people and the current number of users selecting the event is only 10, the event ID of the event can still be registered by selecting the event after the selection deadline on or after September 29.

The registration control unit 208 allows the registration of multiple event IDs. These multiple events may include one event (a first event) and another event (a second event). The one event and the other event may both be competitive or match game events of the same game title. The one and other events may take place on the same day, or the first event may occur earlier than the second event.

The registration control unit 208 may allow the registration of the other event depending on the relationship between the one and other events. This relationship therebetween may be based on the schedule (event date) of the one and other events, meaning the registration control unit 208 may allow the other event to be registered depending on the schedule of the first and second events. The event schedule includes information about the date and time of the event.

Furthermore, the registration control unit 208 may allow the other event to be registered on condition that there is a specified amount of time between the event date (schedule) of the one event and that of the other event. The specified time can be determined based on event-related information associated with the event ID, or it may be determined based on the event date (or schedule) and location of the one and other events associated with the event ID of the one event and that of the other event. For example, the specified time can be determined based on whether a user(s) can participate in both the one and other events according to their schedules (event dates) and locations. The specified time can also be modified and registered.

Additionally, the registration control unit 208 may allow the user to select and register the other event if the registration of the one event has been canceled by user operation.

The registration control unit 208 may allow the registration of match results on condition that a match with an opponent has been completed. The registration control unit 208 may also allow the registration of match results on condition that the opponent user has approved the match result. For example, when information indicating the match result is received from the user terminal 10 of one user, the match result and an icon to approve or disapprove the result may be presented on the opponent user's terminal, and the match result may be registered if the opponent selects the icon indicating approval.

The registration control unit 208 may be configured to register the event ID of one event selected by the user, from among multiple events which are associated with one game title selected by the user and associated with the user ID of the user, so as to be associated with the user ID. Furthermore, the registration control unit 208 may allow the registration of the event ID of one event associated with one schedule, based on selection by the user, from event IDs of multiple events with the same event name but different schedules (event dates).

The registration control unit 208 may allow the registration of an event hosting application submitted by an event organizer who wishes to hold an event. The event hosting application may include information contained in the event-related information, and may be registered in associated with the event ID.

The matching control unit 209 performs match-making between users. The match-making between users may be performed on condition that the users check in at the event venue. In the present embodiment, another user matched with one user becomes the opponent of the one user.

The matching control unit 209 may control match-making between one user (a first type user) and another user (a second type user) who have selected and registered the same event so as to be associated with the respective user IDs on different days. For example, one user may be a user with the user ID, which is ID U001, in the table B shown in FIG. 4B, and another user may be a user with the user ID, which is ID U003, in the table B in FIG. 4B. The one user registered for an event whose ID is E002, on September 23, while the other user registered for the same event whose ID is E002, on a different date, October 1. In this way, the one user who registered during a preferred period set by the event organizer can be classified as the first type user, and another user who registered during a non-preferred period can be classified as the second type user, whereby setting may be made so that the first type user to enjoy benefits, which are not available to the second type user. The event organizer can freely define what constitutes a preferred or non-preferred period. Additionally, the matching control unit 209 may control the match-making between one user and another user based on the event schedule (event date) of one event. For example, the event schedule is October 1 which is the event schedule of an event whose event ID is E002. The matching control unit 209 may also perform control to enable match-making between the first-type users, or between the second-type users.

Users who select and register for one event during a first period so as to be associated with their user IDs respectively may be classified as the first type users, and users who select and register for the one event during a second period which follows the first period so as to be associated with their user IDs, can be classified as the second type users. The first period can be set as a longer period than the second period. In the case of the event whose event ID is E002 shown in FIG. 4C, for example, the first period may be September 1 to 23, and the second period may be September 24 to October 1. However, this is not limited to these dates, and users who select and register for the one event before the day prior to the event date may be classified as the first type users, while users who select and register on the day of the one event may be classified as the second type users.

[symbol] The registration control unit 208 may register the user ID of the second type user in association with the event ID of the one event up until the event's start time on the event day. The registration control unit 208 may allow the user ID of the second type user to be registered in association with the event ID of the one event on condition that the number of user IDs of users who select and register the one event in association with the event ID of the one event is smaller than the event participation capacity.

The registration control unit 208 may control the registration of match game results for the first type users, while preventing the registration of match game results for the second type users.

The check-in determination unit 210 determines whether a user checks in at the event venue. The check-in determination unit 210 may determine that the user checks in at the event venue on condition that the location information indicates that the user terminal 10 is located at the event venue. The location information of the user terminal 10 may be information from global positioning system (GPS) which is provided in the user terminal 10. The check-in determination unit 210 may determine that the user checks in at the event venue conditioned on acquisition of identification information presented by the user terminal 10. The identification information presented by the user terminal 10 may be any information as long as it can identify the user. In the present embodiment, it is a two-dimensional code such as a QR code (registered trademark).

The notification information is sent to the user terminal 10 by the server device 20 of the notification control unit 211, and the notification information is presented to the user through the user terminal 10. The notification control unit 211 can notify the user terminal 10 of the user of information related to the opponent user of a competitive game during the event schedule. The notification control unit 211 may perform control to notify the user of information related to the opponent user on condition that the first type users are matched with each other. In addition, the notification control unit 211 may perform control to make it impossible to notify the user of the information related to the opponent user on condition the first type user is matched with the second type user or that the second type users are matched with each other.

In a state where an event requires winning of a lottery is selected, when the user wins the lottery, the notification control unit 211 may notify the user terminal 10 of users who have wins the lottery, of information to the effect that the user has won the lottery, by the predetermined date. The predetermined date may be the day before the event schedule. Additionally, the notification control unit 211 may notify, via the user terminal 10, the user of information to the effect that the user is placed on a waiting list when the user loses the lottery. Furthermore, when the user loses the lottery, the notification control unit 211 may notify the user terminal 10 of the user, of information to the effect that the user is placed on a waiting list, and further notify the user terminal of the user who is on the waiting list, of information to the effect that the user wins the lottery on condition that that a cancellation occurs.

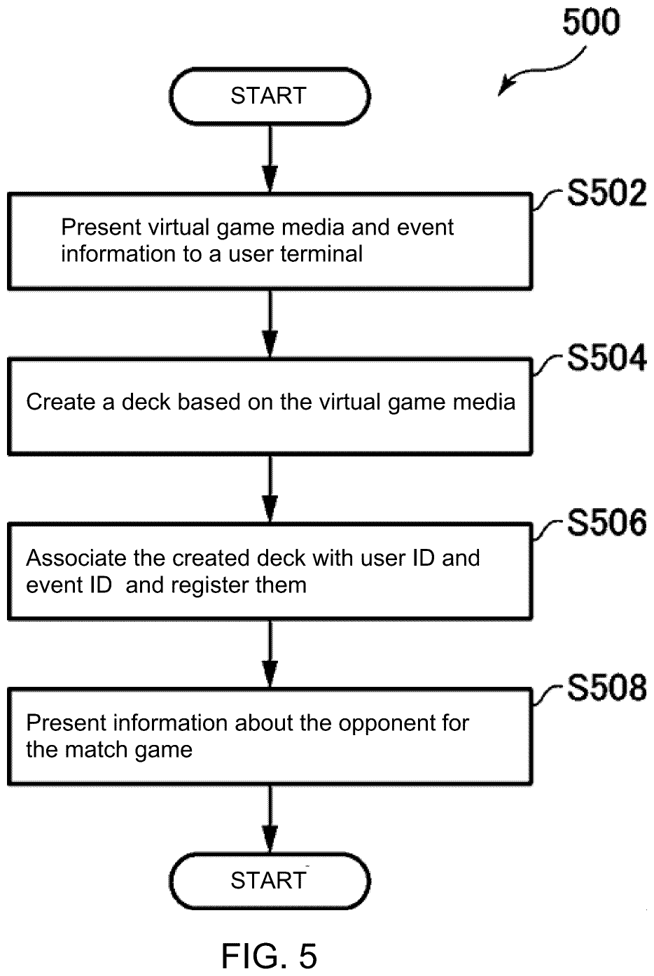

An operation 500 of the system according to the present embodiment will be described with reference to FIG. 5. In step S502, the server apparatus 20 presents multiple virtual game media and multiple pieces of event information to the user terminal 10. The user terminal 10 can display the presented information to the user via the display unit 102. From the presented event information, the user can select an event the user wants to participate in.

In step S504, a deck is created based on the virtual game media selected by user input from among the virtual game media presented on the user terminal 10.

In step S506, the created deck is registered so as to be associated with the user ID and the event ID.

In step S508, the opponent information for the competitive game is controlled to be presented.

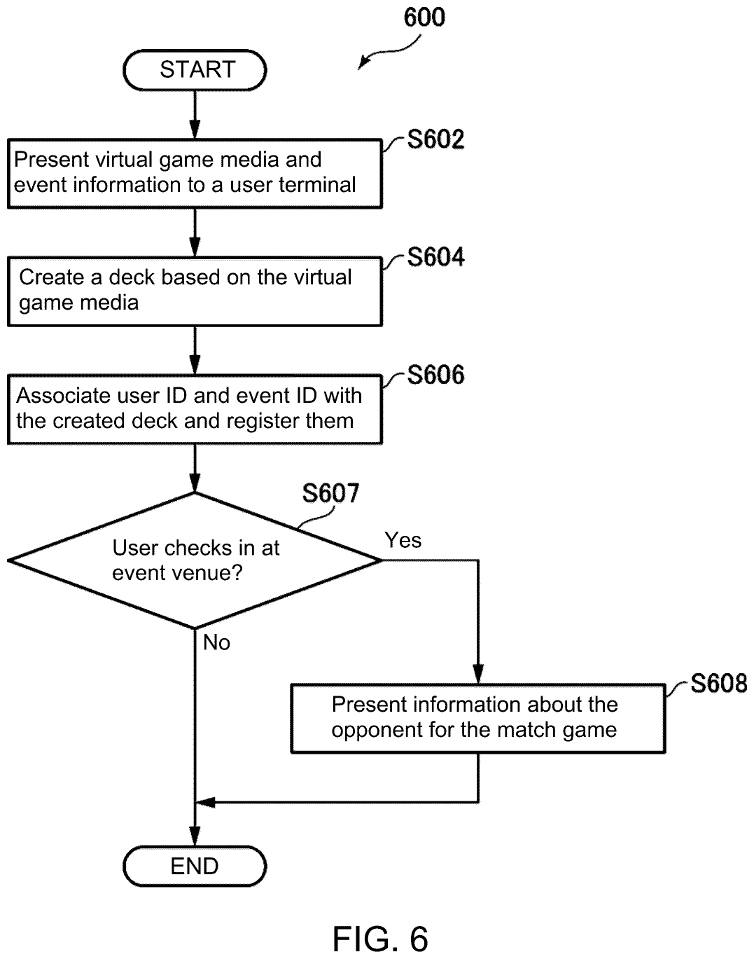

An operation 600 of the system according to another embodiment will be described with reference to FIG. 6. The operation 600 includes an operation of step S607 in addition to the operation 500. Steps S602 to S606 are executed in the same manner as the steps S502 to S506 in FIG. 5. In step S607, when it is determined that the user checks in at the event venue, an operation is performed in the same manner as step S508 in FIG. 5. Therefore, the operation of step S607 may be included additionally in FIG. 5.

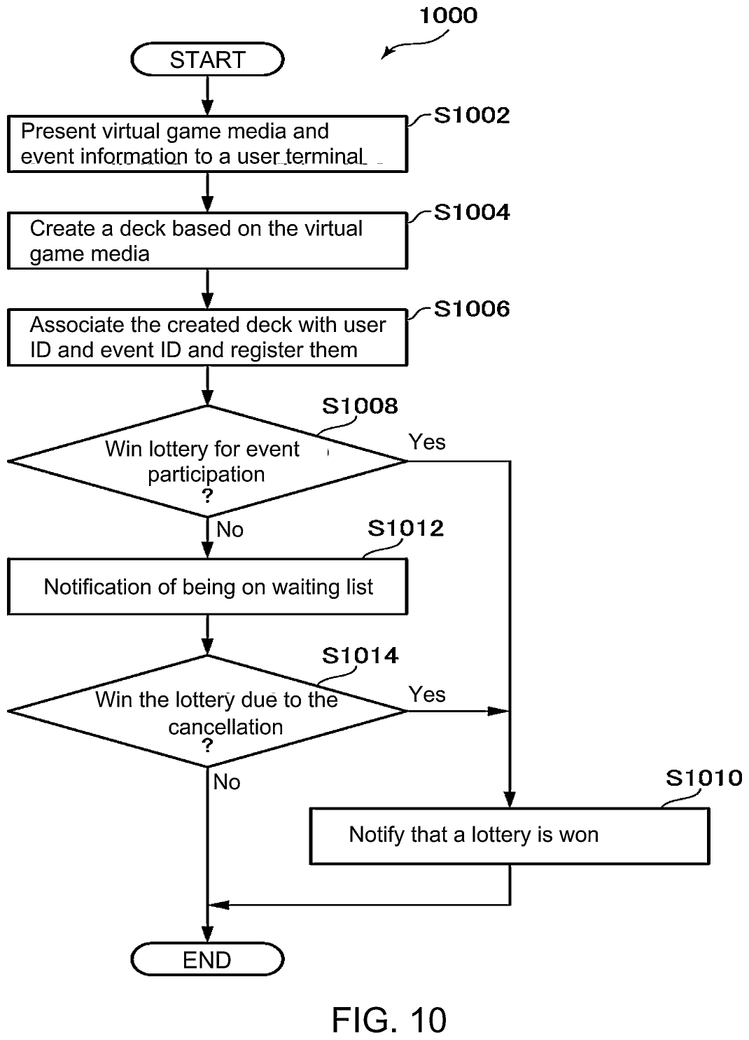

An operation 1000 of the system according to yet another embodiment will be described using FIG. 10. Steps 1002 to 1006 are executed in the same manner as steps S502 to S506 in FIG. 5. In the case of an event where winning of a lottery is required, in step S1008, it is determined whether the use wins the lottery for participation in the event. If the user wins the lottery, in step S1010, the user terminal 10 is notified of information to the effect that the user wins the lottery. On the other hand, if the user loses the lottery, in step S1012, the user terminal 10 is notified of information to the effect that the user is on a waiting list. Then, in step S1014, it is determined whether the user on the waiting list wins the lottery due to a cancellation by another. When the user wins the lottery due to the cancellation by another, in step S1010, the user terminal 10 is notified of information to the effect that the user wins the lottery.

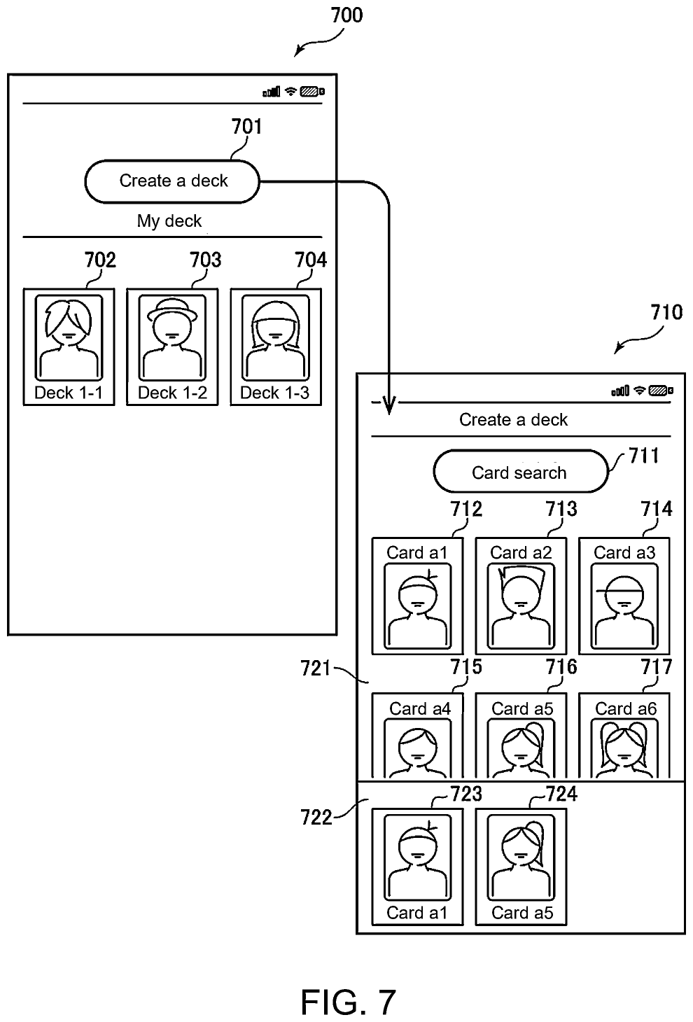

FIGS. 7 to 9 show examples of application screens 700, 800, and 900 displayed on the display unit 102 of the user terminal 10 when the event management service is provided. In the present embodiment, the app (application) used on the user terminal 10 is a dedicated application for the event management service installed on the user terminal 10. Using the dedicated application, a user input is sent to the server apparatus 20, and information is presented to the user based on that the information sent from the server apparatus 20. In another embodiment, a general browser application may be used instead of the dedicated application. The presentation control unit 206 may present multiple icons, which can be selected by the user on the app screen displayed on the user terminal 10. The presentation control unit 206 may present at least one different icon on the app screen shown on the user terminal 10 before and after the check-in for the registered event.

FIG. 7 shows an app screen 700 where the user creates a deck. When the user terminal 10 accepts a selection of the deck creation icon 701, the app screen 710 is displayed. On the app screen 710, multiple cards 712, 713, 714, 715, 716, 717, . . . which are multiple virtual game media are presented, and the user can select one or more of virtual game media from the multiple virtual game media to create a deck. Additionally, the presentation control unit 206 may display the app screen 710 which includes virtual game media that correspond to real game media the user does not possess. The presentation control unit 206 may also display multiple virtual game media and the selected one or more virtual game media in separate areas of the app screen 710. For example, the multiple game media may be displayed in an upper area (first area) 721 of the app screen 710, and the virtual game media 712 and 716 selected therefrom may be displayed as selected virtual game media 723 and 724 in a lower area (second area) 722 of the app screen 710. A deck may also be created based on the selected virtual game media, which are presented in the lower area 722 of the app screen 710.

The presentation control unit 206 may also present deck creation criteria (criterion). If the deck that does not meet these criteria is created by the deck creation control unit 207, it may allow its creation, or the notification control unit 211 may notify the user of information to the effect that the deck does not meet the criteria. The notification of the information to the effect that the deck does not meet the criteria may be displayed in the lower area 722 of the app screen 710. Additionally, the deck creation criteria may be associated with the event ID of one event, and the registration control unit 208 may make it impossible to register the deck that does not meet the criteria, in association with the event ID of the one event.

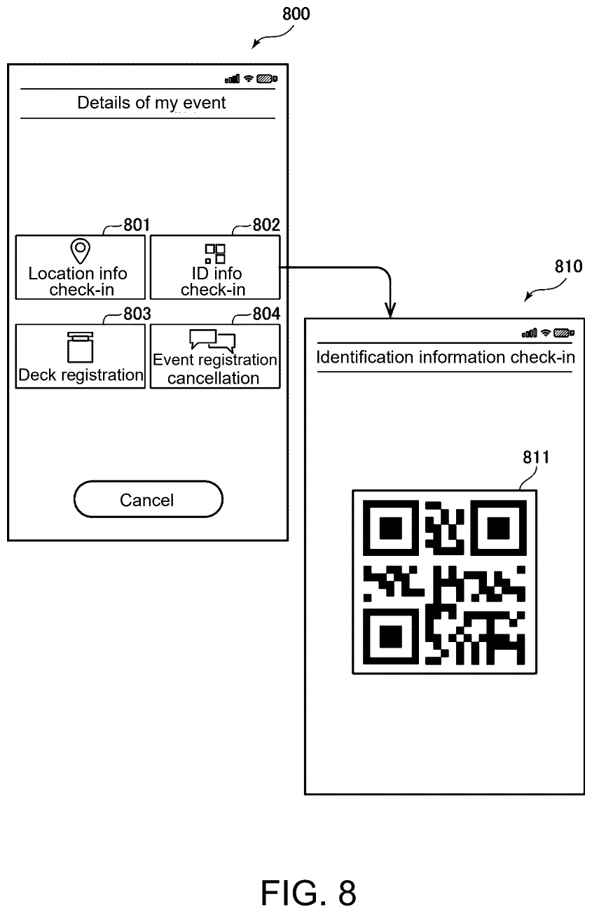

FIG. 8 shows the app screen 800 before the user checks in at the event venue. In the present embodiment, on the app screen 800, a location information check-in icon 801, an identification information check-in icon 802, a deck registration icon 803, and an event registration cancellation icon 804 are shown. The user can select the method of check-in at the event venue by selecting either the location information check-in icon 801 or the identification information check-in 802. When the user selects the location information check-in icon 801, the user terminal 10 can send the location information of the user terminal 10 to the server apparatus 20. Additionally, by selecting the identification information check-in icon 802, the app screen 810 is displayed, and the user terminal 10 can present the user identification information 811 to the app screen 810. In the present embodiment, a QR code (registered trademark) containing user identification information is presented. The user identification information can be obtained by a barcode reader or the like that can read the presented QR code (registered trademark). The obtained user identification information can be sent to the server apparatus 20. Based on at least one of a condition that the user terminal 10 is located at the event venue and a condition that the user identification information presented by the user terminal 10 at the event venue is obtained, the check-in determination unit 210 may determine that the user has checked in at the event venue. Additionally, the presentation control unit 206 may present the location information check-in icon 801 and the identification information check-in icon 802 that are valid only on the day the event is held. By selecting the event registration cancellation icon 804, the user can cancel the registration of the registered event.

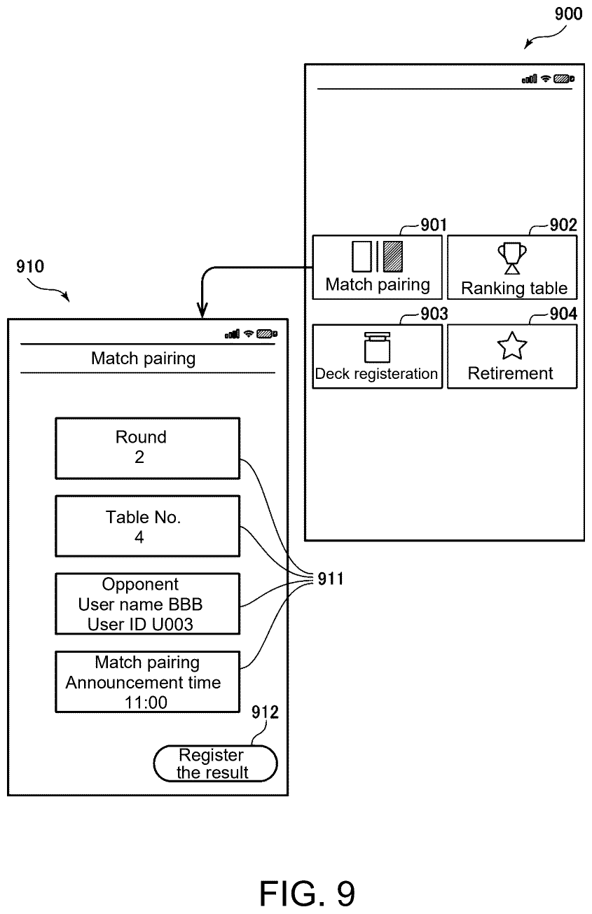

FIG. 9 shows the app screen 900 after the user checks in at the event venue. On the app screen 900, a match pairing icon 901, a ranking table icon 902, and a deck registration icon 903 are shown. In the present embodiment, the location information check-in icon 801, the identification information check-in icon 802, and the event registration cancellation icon 804 that were shown on the app screen 800 before the user checks in, are no longer shown on the app screen 900 after the check-in. Instead, the match pairing icon 901, the ranking table icon 902, and a retirement icon 904, which were not shown on the app screen 800, are shown. By selecting the match pairing icon 901, the app screen 910 is displayed. On the app screen 910, matchup information 911 is presented. The matchup information 911 includes information related to the pairing. In this embodiment, the matchup information 911 can include information such as round information for the match game against the opponent in the event that the user has registered for, table number information, opponent information, and information indicating the time when the matchup is announced. Additionally, on the app screen 910, a result registration icon 912 is displayed. By the registration control unit 208, after the match game against the opponent has concluded, the user can register match game result information by selecting the result registration icon 912. The registration of the match game result information can be performed by having one of the user and the opponent temporarily register the match game result information, and the other approves the temporarily registered match game result information to finalize the registration of the match game result information. Furthermore, by selecting the ranking table icon 902, the user can view the match game result information against the opponent in the event that the user has registered for. The match game result information may include information on the user's ranking in the match game. Additionally, by selecting the retirement icon 904, the user can retire from the match game against the opponent in the event that the user has registered for.

On the app screens 800 and 900, before and after the check-in, the deck registration icons 803 and 903 are displayed, respectively. By selecting the deck registration icon 803 or 903, the user can choose and register the deck to be used for the event from the decks created on the app screen 700 or 710.

In the above embodiments of the present invention, the event management system 1 includes the presentation control unit 206, the deck creation control unit 207, and the registration control unit 208. With this configuration, users can check opponent information after checking in. This allows the event management system 1 provided by this system to offer highly engaging events for users who participate in the events.

Unless specifically mentioned otherwise, the above effects and functions apply to other embodiments and examples as well.

In another embodiment of the present invention, the functions and information processing of the embodiments described above can also be realized by a program or a computer-readable storage medium storing the program. In other embodiments, the functions and information processing according to the embodiments described above can be realized as a method. In other embodiments, it can be realized by a server that supplies the program realizing the functions and information processing in the embodiments described above to a computer. Furthermore, in other embodiments, the functions and information processing in the embodiments described above can be realized as a virtual machine or cloud system.

In one or more embodiments of the present invention, as long as the same functions as the embodiments of the present invention can be realized, part of the functions of the server apparatus 20 may be provided by the user terminal 10, or part of the functions of the user terminal 10 may be provided by the server apparatus 20.

In the processes or operations described above, unless there is a processing or operational inconsistency such as using data that should not yet be available in a certain process, the processes or operations can be freely changed. The embodiments described above are examples to explain the present invention, and the present invention is not limited to these embodiments. The present invention can be implemented in various forms without departing from the spirit of the invention.

Part or all of the above embodiments may also be described as follows, but are not limited to the following:

[Note A1] An event management apparatus according to an embodiment of the present invention which can communicate with a user terminal, comprises a presentation control unit for presenting multiple first game media and multiple events using second game media corresponding to the first game media to the user terminal, a deck creation control unit for creating a deck based on first game media selected from the presented multiple first game media, and a registration control unit for registering identification information of one user\, the created deck, and event identification information of one event selected from the multiple events, wherein the first game media are virtual game media and the second game media are real game media.

[Note A2] In the event management apparatus according to [Note A1], the registration control unit allows registration of the created deck in association with the user identification information and the event identification information of the selected one event.

[Note A3] In the event management apparatus according to [Note A1] or [Note A2], a second game medium which corresponds to a first game medium is associated with the same character as that associated with the one of first game media.

[Note A4] In the event management apparatus according to any one of [Note A1] to [Note A3], the registration control unit is configured to allow registration of the event identification information of the one event selected from among the multiple events which are associated with one game title which is selected from the multiple game titles, so as to be associated with the user ID.

[Note A5] In the event management apparatus according to any one of [Note A1] to [Note A4], the registration control unit allows registration of event identification information of one event, which is associated with one event schedule (event date), and which is selected by the user from among pieces of event identification information of multiple events associated with the same event name and a different event schedule (event date).

[Note A6] In the event management apparatus according to any one of [Note A1] to [Note A5], the multiple events includes an event for which wining of a lottery is required.

[Note A7] The event management apparatus according to any one of [Note A1] to [Note A6], further includes a notification control unit configured to notify the user, wherein the notification control unit notifies that the lottery has been won, by a predetermined date, when the lottery is won in a state where the event for which the wining of the lottery is required, is selected.

[Note A8] In the event management apparatus according to any one of [Note A1] to [Note A7], the predetermined date is a day before a date of the event for which the winning of the lottery is required.

[Note A9] In the event management apparatus according to any one of [Note A1] to [Note A8], the notification control unit notifies that the user is placed on a waiting list when the lottery is lost.

[Note A10] In the event management apparatus according to any one of [Note A1] to [Note A9], the notification unit notifies that the lottery is won, on condition that the user is notified that the user is on the waiting list and a cancellation occurs.

[Note A11] In the event management apparatus according to any one of [Note A1] to [Note A10], a selection available period and a capacity are set for each of the multiple events.

[Note A12] In the event management apparatus according to any one of [Note A1] to [Note A11], the registration control unit allows a selection and registration of one event even after a selection available period set for the one event, when the number of users who select the one event is smaller than the capacity.

[Note A13] In the event management apparatus according to any one of [Note A1] to [Note A12], the registration unit allows registration of user information, and a game title can be registered as the user information.

[Note A14] In the event management apparatus according to any one of [Note A1] to [Note A13], the registration control unit allows the registration of user information, and the language of the game title can be registered as the user information.

[Note A15] In the event management apparatus according to any one of [Note A1] to [Note A14], the presentation control unit can present the first game media in a first area, and present first game media selected from the presented first game media in a second area.

[Note A16] In the event management apparatus according to any one of [Note A1] to [Note A15], the deck creation control unit can create a deck based on the first game medium presented on the second area.

[Note A17] In the event management apparatus according to any one of [Note A1] to [Note A16], the presentation control unit can present, in the first area, first game media corresponding to a second game media which the user does not possess.

[Note A18] In the event management apparatus according to any one of [Note A1] to [Note A17], the presentation control unit presents deck creation criteria, and can create a deck which does not meet the deck creation criteria.

[Note A19] In the event management apparatus according to any one of [Note A1] to [Note A18], the notification control unit can notify, in the second area, that the created deck does not meet the deck creation criteria when the deck that does not meet the criteria is created.

[Note A20] In the event management apparatus according to any one of [Note A1] to [Note A19], the registration control unit is configured so that the deck which does not meet the deck creation criteria, cannot be registered so as to be associated with the selected one event.

[Note A21] In the event management apparatus according to any one of [Note A1] to [Note A20], multiple characters are set for each game title, and the deck creation control unit is configured to create a deck including the same characters.

[Note A22] In the event management apparatus according to any one of [Note A1] to [Note A21], the registration control unit controls a registration of an event hosting application submitted by an event organizer who wishes to hold an event, and the event hosting application may include game titles available at the event, an event date, and the event venue.

[Note A23] An event management computer program according to an embodiment of the present invention, causes one or more computers to function as a presentation control unit for presenting multiple first game media and multiple events using second game media corresponding to the first game media to the user terminal, a deck creation control unit for creating a deck based on first game media selected from the presented multiple first game media, and a registration control unit for registering identification information of one user, the created deck, and one event selected from the multiple events, wherein the first game media are virtual game media and the second game media are real game media.

[Note A24] An event management system according to an embodiment of the present invention comprises a user terminal and an event management apparatus communicably connected to the user terminal, a presentation control unit for presenting first game media and events using second game media, which correspond to the first game media, to the user terminal, a deck creation control unit for creating a deck based on first game media selected from the presented first game media, and a registration control unit capable of registering the created deck, and one event selected from the multiple events, wherein the first media are virtual game media, and the second media are real game media.

[Note B1] An event management apparatus according to an embodiment of the present invention which can communicate with a user terminal, comprises a presentation control unit for presenting multiple first game media and multiple events using second game media corresponding to the first game media, to the user terminal, a deck creation control unit for creating a deck based on first game media selected from the presented multiple first game media, and a registration control unit for registering the created deck, two or more events including a first event and a second event, which are selected from the multiple events, wherein the registration control unit perform control so that the second game media can be registered according to relationship between the first event and the second event.

[Note B2] In the event management apparatus according to [Note B1], the registration control unit performs control so that the second event can be registered according to time of the first event and the second event.

[Note B3] In the event management apparatus according to [Note B1] or [Note B2], the registration control unit perform control so that the selected second event can be registered, on condition that time between the event time of the selected and registered first event and that of the selected second event is equal to or greater than a predetermined time.

[Note B4] In the event management apparatus according to any one of [Note B1] to [Note B3], the first event and the second event are held on the same day, and the first event is scheduled earlier than the second event.

[Note B5] In the event management apparatus according to any one of [Note B1] to [Note B4], the registration control unit performs control so that the selected second event can be registered by canceling the registration of the registered first event.

[Note B6] In the event management apparatus according to any one of [Note B1] to [Note B5], each of the first event and the second event is a competitive game event for one game title.

[Note B8] In the event management apparatus according to any one of [Note B1] to [Note B7], the presentation control unit can present the created deck to the competitive game opponent.

[Note B8] In the event management apparatus according to any one of [Note B1] to [Note B7], the presentation control unit can present the created deck to the opponent of the competitive game.

[Note B9] In the event management apparatus according to any one of [Note B1] to [Note B8], the registration control unit allows registration of a match result, on the condition that the competitive game with the opponent ends.

[Note B10] In the event management apparatus according to any one of [Note B1] to [Note B9], the registration control unit allows registration of the match result on condition that the opponent approves the match result.

[Note B11] In the event management apparatus according to any one of [Note B1] to [Note B10], the registration control unit allows the registration of user information, and the game title can be registered as the user information.

[Note B12] In the event management apparatus according to any one of [Note B1] to [Note B11], the registration control unit allows the registration of user information, and events for the game titles registered as the user information can be registered.

[Note B13] In event management apparatus according to any one of [Note B1] to [Note B12], the registration control unit allows registration of a created deck in association with the selected event.

[Note B14] In the event management apparatus according to any one of [Note B1] to [Note B13], the registration control unit allows modification and registration of the predetermined time.

[Note B15] In the event management device is as described in any one of [Note B1] to [Note B14], the registration control unit can further perform control so that an event application from an event organizer who wishes to host an event can be registered, and the event application includes information on at least a game title playable at the event, the event schedule (event date), and the event venue.

[Note B16] An event management computer program according to the present invention, causes one or more computers to function as a presentation control unit for presenting multiple first game media and multiple events using second game media corresponding to the first game media, to the user terminal, a deck creation control unit for creating a deck based on first game media selected from the presented multiple first game media, and a registration control unit for registering the created deck, two or more events including a first event and a second event selected from the multiple events, wherein the registration control unit can perform control so that the second event can be registered according to relationship between the first event and the second event.

[Note B17] An event management system according to the present invention including a user terminal and the event management apparatus, which can be communicatively connected therebetween, comprises a presentation control unit for presenting multiple first game media and multiple events using second game media corresponding to the first game media, to the user terminal, a deck creation control unit for creating a deck based on first game media selected from the presented multiple first game media, and a registration control unit for registering the created deck, and two or more events including a first event and a second event which are selected from the multiple events, wherein the registration control unit can perform control so that the second event can be registered according to relationship between the first event and the second event.

[Note C1] An event management apparatus according to an embodiment of the present invention which can communicate with a user terminal, comprises a presentation control unit for presenting multiple first game media and multiple events using second game media corresponding to the first game media, to the user terminal, a deck creation control unit for creating a deck based on first game media selected from the presented multiple first game media, and a registration control unit for registering the created deck, and one event selected from the multiple events, and a matching control unit for match-making users with each other wherein the matching control unit performs control so that a first type user and a second user who register one event on different dates can be matched with each other.

[Note C2] In event management apparatus according to [Note C1], the matching control unit performs control so that the first type user and the second type user are matched on a holding date of the one event.

[Note C3] The event management apparatus according to either [Note C1] or [Note C2], further comprises a check-in control unit for controlling check-in at an event venue where the one event is held, and the matching control unit performs control so that the first type user and the second type user can be matched with each other, on condition that the first type user and the second type user check in at the event venue.

[Note C4] In the event management apparatus according to any one of [Note C1] to [Note C3], the first type user is a user who registers for one event during a first period, and the second type user is a user who registers for the one event during a second period following the first period.

[Note C5] In event management apparatus according to any one of [Note C1] to [Note C4], the first period is longer than the second period.

[Note C6] In the event management apparatus according to any one of [Note C1] to [Note C5], the first type user is a user who registers for the one event before the event day, and the second type user is a user who registers for the event on the event day.

[Note C7] In the event management apparatus according to any one of [Note C1] to [Note C6], the registration control unit performs control so that the second type user can register the one event, up until the scheduled event time on the event day.

[Note C8] In the event management apparatus according to any one of [Note C1] to [Note C7], the capacity is set for the one event, and the registration control unit performs control so that the second type user can register the one event, on condition that the number of users who register for the one event is below the capacity.

[Note C9] In the event management apparatus according to any one of [Note C1] to [Note C8], the one event is a competitive game using a real deck made up of the second game media which correspond to the created virtual deck, and the registration control unit performs control so that a match result of the competitive game can be registered.

[Note C10] In the event management apparatus according to any one of [Note C1] to [Note C9], the matching unit further performs control so that the first type user can be matched with another first type user and the second type user can be matched with another second type user.

[Note C11] In the event management apparatus according to any one of [Note C1] to [Note C10], the registration control unit performs control so that the first type user can register a match result but the second type user cannot register a match result.

[Note C12] The event management apparatus according to any one of [Note C1] to [Note C11], further comprises a notification control unit for notifying a player of information about an opponent who is matched, and the notification control unit performs control so that the information about the opponent can be notified on the event holding date.

[Note C13] The event management apparatus according to any one of [Note C1] to [Note C12], the notification control unit performs control so that the information about the opponent can be notified after the check-in at the event venue.

[Note C14] In the event management apparatus according to any one of [Note C1] to [Note C13], the notification control unit performs control so that the information about the opponent is notified on condition that first type users are matched with each other.

[Note C15] In the event management apparatus according to any one of [Note C1] to [Note C14], the notification control unit performs control so that the information about the opponent can be notified, on condition that a first type user and a second type user are matched with each other, or second type users are matched with each other.

[Note C16] In event management apparatus according to any one of [Note C1] to [Note C15] the registration control unit performs control so that an event holding application from an event organizer, who wishes to host an event, can be registered, and the event holding application includes information about at least game titles playable at the event, the event date, and the event venue.

[Note C17] An event management computer program according to an embodiment of the present invention causes one or more computers to function as a presentation control unit for presenting multiple first game media and multiple events using second game media corresponding to the first game media, to the user terminal, a deck creation control unit for creating a deck based on first game media selected from the presented multiple first game media, and a registration control unit for registering the created deck, and one event selected from the multiple events, and a matching control unit for match-making users with each other, wherein the matching control unit match-makes a first type user and a second user who register one event on different dates.

[Note C18] An event management system according to an embodiment of the present invention comprises a user terminal and an event management device which are communicably connected to each other, a presentation control unit for presenting multiple first game media and multiple events using second game media corresponding to the first game media, to the user terminal, a deck creation control unit for creating a virtual deck based on first game media selected from the presented multiple first game media, and a registration control unit for registering the created deck, and one event selected from the multiple events, and a matching control unit for match-making users with each other, wherein the matching control unit match-makes a first type user and a second user who register one event on different dates.

Although preferred embodiments have been described above to explain the present invention, the present invention is not necessarily limited to the above-described embodiments, and various modifications and implementations can be made within the scope of the technical idea of the present invention.

1. An event management apparatus which can communicate with a user terminal comprising:
a presentation control unit configured to present multiple first game media and multiple events using second game media corresponding to the first game media, to the user terminal;
a deck creation control unit configured to create a deck including a first game medium selected from the presented multiple first game media; and
a registration control unit configured to register the created deck, two or more events including a first event and a second event, which are selected from the multiple events,
wherein the registration control unit perform control so that the second game media can be registered according to relationship between the first event and the second event.

2. The event management apparatus according to claim 1, wherein the registration control unit performs control so that the second event can be registered according to time of the first event and the second event.

3. The event management apparatus according to claim 1, wherein the registration control unit perform control so that the selected second event can be registered, on condition that time between event time of the selected and registered first event and that of the selected second event is equal to or greater than a predetermined time.

4. The event management apparatus according to claim 1, wherein the first event and the second event are held on a same day, and the first event is scheduled earlier than the second event.

5. The event management apparatus according to claim 1, wherein the registration control unit performs control so that the selected second event can be registered by canceling registration of the registered first event.

6. The event management apparatus according to claim 1, wherein each of the first event and the second event is a competitive game event for one game title.

7. The event management apparatus according to claim 1, further including a control unit, and the notification control unit is configured to perform a notification of information of an opponent in a competitive game on an event date.

8. The event management apparatus according to any one of claim 1, wherein the presentation control unit is configured to present the created deck to an opponent of a competitive game.

9. The event management apparatus according to claim 1, wherein the registration control unit is configured to register a match result, on condition that a competitive game with an opponent ends.

10. The event management apparatus according to claim 1, wherein the registration control unit is configured to register a match result, on condition that an opponent approves the match result.

11. The event management apparatus according to claim 1, wherein the registration control unit is configured to register user information, and a game title can be registered as the user information.

12. The event management apparatus according to claim 1, wherein the registration control unit is configured to register user information, and an event for a game title can be registered as the user information.

13. The event management apparatus according to claim 1, wherein the registration control unit is configured to register the created deck in association with the selected events.

14. The event management apparatus according to claim 3, wherein the registration control unit is configured to modify and register the predetermined time.

15. The event management device according to claim 1, wherein the registration control unit can further perform control so that an event application from an event organizer who wishes to host an event can be registered, and the event application includes information on at least a game title playable at the event, the event date, and an event venue.

16. An event management computer program causes one or more computers to function as:
a presentation control unit configured to present multiple first game media and multiple events using second game media corresponding to the first game media, to the user terminal,
a deck creation control unit configured to create a deck including a first game medium selected from the presented multiple first game media, and
a registration control unit configured to register the created deck, two or more events including a first event and a second event selected from the multiple events,
wherein the registration control unit can perform control so that the second event can be registered according to relationship between the first event and the second event.

17. An event management system comprising:
a user terminal;
an event management apparatus, which can be communicatively connected therebetween,
a presentation control configured to present multiple first game media and multiple events using second game media corresponding to the first game media, to the user terminal,
a deck creation control unit configured to create a deck including a first game medium selected from the presented multiple first game media, and
a registration control unit configured to register the created deck, and two or more events including a first event and a second event which are selected from the multiple events,
wherein the registration control unit can perform control so that the second event can be registered according to relationship between the first event and the second event.
